(19) United States
(12) Patent Application Publication
(10) Pub. No.: US 2014/0312732 A1
(43) Pub. Date: Oct. 23, 2014

(54) WINDSCREEN WIPER MOTOR

(71) Applicant: Valeo Systèmes d'Essuyage, Le Mesnil Saint Denis (FR)

(72) Inventors: Christof Heuberger, Freiberg (DE); Siegfried Stefani, Oberriexingen (DE); Werner Hartmann, Vaihingen/Enz (DE)

(73) Assignee: VALEO SYSTÈMES D'ESSUYAGE, Le Mesnil Saint Denis (FR)

(21) Appl. No.: 14/358,382

(22) PCT Filed: Nov. 8, 2012
(86) PCT No.: PCT/EP2012/072084

§ 371 Date: May 15, 2014

(30) Foreign Application Priority Data
Nov. 15, 2011 (DE) 10 2011 055 336.3

(51) Int. Cl. B60S 1/08; H02K 13/00

(52) U.S. Cl. CPC B60S 1/08; H02K 13/00
USPC 310/239

(57) ABSTRACT

A windscreen wiper motor (1), with a shaft (30) carrying an armature (35) and a collector (36), wherein the collector (36) cooperates with brushes (38), which are arranged on a brush carrier device (25), and wherein the brush carrier device (25) is arranged fixedly in a windscreen wiper motor housing (11), wherein the brush carrier device (25) has at least a first opening (39) constructed as an aperture, which is penetrated by a preferably cone-shaped extension (41) connected with the windscreen wiper motor housing (11), that on the side facing away from the fastening side of the extension (41) in the windscreen wiper motor housing (11) the extension (41) projects over the brush carrier device (25) in the region of the at least one first opening (39), and that a securing element (50) is connected with the brush carrier device (25), which securing element on the axial moving relative to each other of the extension (41) and of the securing element (50) jams with the extension (41) and thereby secures the brush carrier device (25) on the extension (41) in the longitudinal direction of the shaft (30).

### PRIOR ART

The invention relates to a windscreen wiper motor according to the preamble of claim 1.

A windscreen wiper motor of this type is already known from practice and has a shaft carrying an armature, said shaft being arranged within a windscreen wiper motor housing. The windscreen wiper motor housing therefore normally consists of two housing half shells receiving the shaft at least in the region of the armature. Alternatively, housing constructions are known that consist of a motor housing and a transmission housing connected to the motor housing in the region of a connection flange. Brushes, which are arranged fixedly within the windscreen wiper motor housing, are provided to electrically contact the armature or the collector thereof. To this end, it is known to arrange the brushes on a corresponding carrier element and to in turn receive the carrier element with a positive or clamped fit in a corresponding recess between the housing half shells, for example. In addition, it is known from the prior art to fasten the brushes or the holding element thereof in the windscreen wiper motor housing by means of additional fastening elements in the form of screws or the like. Whilst the first-mentioned possibility requires the windscreen wiper motor housing to be formed from two interconnectable housing parts, the second method requires a relatively high assembly effort and is also associated with defects or has to be monitored for defects.

### DISCLOSURE OF THE INVENTION

Proceeding from the presented prior art, the object of the invention is to develop a windscreen wiper motor according to the preamble of claim 1 in such a way that a brush carrier device can be fastened in the windscreen wiper motor housing largely irrespectively of the constructional design of the windscreen wiper motor housing and, at the same time, with relatively low assembly effort. This object is achieved in accordance with the invention with a windscreen wiper motor having the features of claim 1 in that the brush carrier device has at least a first opening constructed as an aperture, which is penetrated by a preferably cone-shaped extension connected with the windscreen wiper motor housing, in that on the side facing away from the fastening side of the extension in the windscreen wiper motor housing the extension projects over the brush carrier device in the region of the at least one first opening, and in that a securing element is connected with the brush carrier device, which securing element on the axial moving relative to each other of the extension and of the securing element jams with the extension and thereby secures the brush carrier device on the extension in the longitudinal direction of the shaft. In other words, this means that the brush carrier device jams with the housing as a result of a simple axial sliding of the brush carrier device onto at least one extension arranged in the housing of the windscreen wiper motor, such that no further assembly steps are necessary.

Advantageous developments of the windscreen wiper motor according to the invention are disclosed in the dependent claims. All combinations of at least two of the features disclosed in the claims, the description and/or the figures fall within the scope of the invention.

In a particularly preferred constructional embodiment of the brush carrier device, it is proposed that the brush carrier device has a brush carrier plate which carries several brushes, that the brush carrier plate has an aperture for the guiding through of the shaft, and that several, preferably two extensions and securing elements are provided, which are arranged in uniform radial angular distances around the aperture. With an embodiment of this type it is possible on the one hand for all brushes or necessary components to be assembled beforehand in the region of the brush carrier plate, such that the brush carrier plate only has to be assembled on the whole as a unit within the windscreen wiper motor housing in a single assembly step. On the other hand, a relatively high rigidity of the brush carrier device is ensured by the geometric design with simultaneously relatively short axial extension (in the longitudinal direction of the shaft).

In an embodiment of the invention that is most preferred in terms of the production process, it is proposed that the windscreen wiper motor housing is constructed as an aluminum pressure die casting at least in the region of the at least one extension, and that the at least one extension is a component part of the aluminum pressure die casting. The at least one extension is thus constructed already with the construction of the housing, without an additional manufacturing step, wherein a relatively good heat dissipation with low weight of the windscreen wiper motor housing is achieved as a result of the construction in the form of an aluminum pressure die casting.

In accordance with a further preferred constructional embodiment of the windscreen wiper motor housing, in the region of the brush carrier device and of the armature the windscreen wiper motor housing is constructed in one piece cylindrically with a mounting opening for a bearing cover, wherein on the side lying opposite the mounting opening a radially inwardly projecting base region is provided, on which the at least one extension is arranged, pointing in the direction of the mounting opening.

In accordance with a further advantageous embodiment, so as to achieve, as easily as possible, an axial delimitation of the path of displacement during the assembly of the brush carrier device, the at least one extension also has a first partial region, which is arranged in the region of the first opening of the brush carrier device, and a second partial region, which adjoins via a stepped shoulder on the side of the first partial region facing away from the brush carrier device, and the shoulder forms an axial stop for the brush carrier device.

In an embodiment of the securing element that is particularly simple and reliable in terms of its function, it is proposed that said securing element is constructed in the form of a securing disc with elastically deformable securing sections, which cooperate with the extension.

So as to ensure the fastening of the securing disc on the brush carrier device or the brush carrier plate, the securing disc has at least one fastening claw, which penetrates the brush carrier device in the region of a second opening constructed as a hole and fastens the securing disc on the brush carrier device such that a passage opening for the extension on the securing disc is aligned with the first opening.

So as to facilitate the assembly of the brush carrier device on the extension, the first region of the extension may also be constructed in pin form with a slightly conical shape. In particular in the case of a pot-shaped housing, with which the extension is no longer readily visible with manual assembly, a “threading” of the brush carrier device on the extension is thus enabled.

Further advantages, features and details of the invention will emerge from the following description of preferred exemplary embodiments and with the help of the drawing, in which:

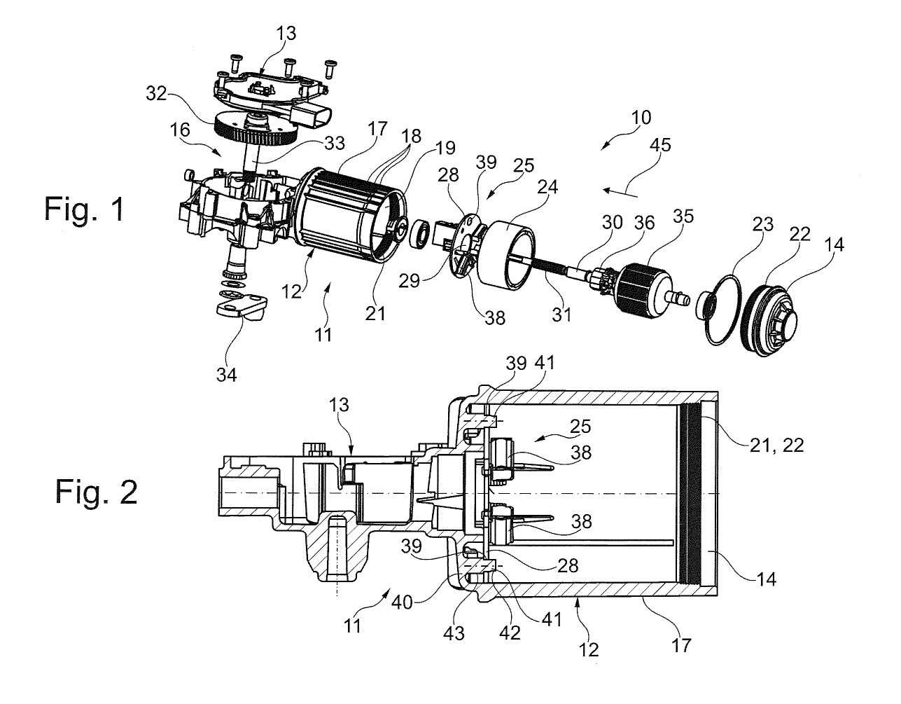

FIG. 1 shows an exploded view of the component parts of a windscreen wiper motor according to the invention,

FIG. 2 shows a longitudinal section through a partially assembled windscreen wiper motor according to FIG. 2,

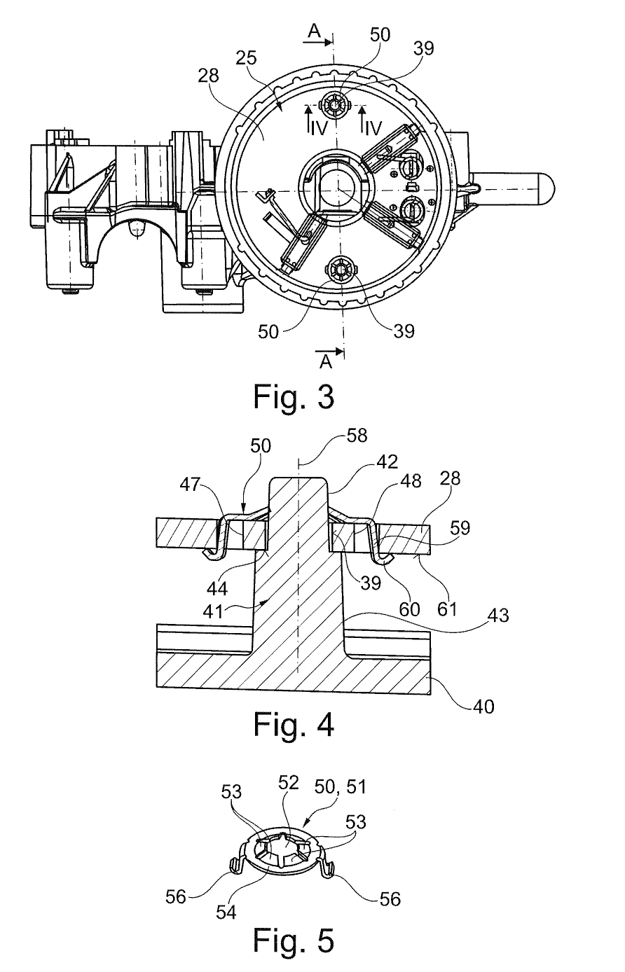

FIG. 3 shows an end-face view of the windscreen wiper motor according to FIG. 2,

FIG. 4 shows a section in the plane IV-IV of FIG. 3, and

FIG. 5 shows a perspective, isolated view of a securing disc used to fasten a brush carrier plate.

Like components and functionally like components are provided with like reference numerals in the figures.

The main component parts of a windscreen wiper motor 10 according to the invention are illustrated in an exploded view in FIG. 1. The windscreen wiper motor 10 comprises a housing 11, which consists of a housing base part 12, a transmission cover 13 and a bearing cover 14. On the side of the housing base part 12 facing away from the bearing cover 14, said housing base part has a transmission mounting region 16 arranged integrally on the housing base part 12. The transmission mounting region 16 is closed by means of the transmission cover 13. The housing base part 12 is preferably constructed from an aluminum pressure die casting and has a cylindrical region 17, on the outer face of which cooling ribs 18 arranged in the longitudinal direction are formed integrally. On the side facing toward the bearing cover 14, the housing base part 12 has a mounting opening 19 for the bearing cover 14. The bearing cover 14 is connected with the housing base part 12 via a threaded connection comprising an inner thread 21 and an outer thread 22, with a ring seal 23 axially interposed.

When the windscreen wiper motor 10 is assembled, a flow ring 24 and a brush carrier device 25 inter alia are arranged within the housing base part 12. The brush carrier device 25 has an annular brush carrier plate 28, which centrally has an aperture 29. An armature shaft 30 penetrates the aperture 29 and has a toothing region 31 at its end facing away from the bearing cover 14, said toothing region meshing with a driving wheel 32, which is used to gear down the speed of the windscreen wiper motor 10. The driving wheel 32 has an output shaft 33, which is used to actuate a wiper rod assembly (not illustrated), for example, via a lever 34.

In the region of the transmission base part 12, the armature shaft 30 also has an armature 35, which is fastened on the armature shaft 30 in a rotationally engaged manner. The armature 35 or the windings thereof, which are not illustrated in greater detail, is/are connected with a collector 36, against which brushes 38 rest in a known manner when the windscreen wiper motor 10 is assembled, said brushes being assembled or fastened on the brush carrier plate 28.

The invention relates to the fastening of the brush carrier device 25 or the brush carrier plate 28 within the housing base part 12 of the housing 11. To this end, the brush carrier plate 28 has several, in the exemplary embodiment two, first openings 39, each in the form of an aperture, arranged offset from one another by 180° and arranged over a pitch circle diameter around the aperture 29. As can best be seen with reference to FIG. 2, on the side facing away from the transmission cover 13, the housing base part 12 has a radially inwardly drawn base region or intermediate region 40, from which an extension 41 projects in the direction of the transmission cover 13 for each first opening 39. The extension 41 formed integrally on the housing base part 12 during the casting process has a first region 42 and a second region 43 of enlarged diameter compared to the first region 42, which both transition into one another via a shoulder 44 (FIG. 4). The second region 43 of the cone-shaped or pin-shaped extension 41 thus has a diameter or a cross-sectional area that is greater than the opening cross section of the first opening 39, such that the shoulder 44 forms an axial stop for the brush carrier plate 28 when the brush carrier plate 28 is assembled in the direction of the arrow 45 (FIG. 1).

In the axial end position of the brush carrier plate 28 on the extension 41 (FIG. 4), the diameter of the first region 42 of the extension 41 is preferably slightly smaller than the size of the first opening 39, such that a certain radial play can be set between the brush carrier plate 28 and the extensions 41. In addition, the first region 42 of the extension 41 is preferably slightly conical, that is to say it has a slightly smaller diameter on the side facing away from the second region 43 than on the side facing toward the second region 43.

As can best be seen with reference to FIG. 4, two second openings 47, 48, in particular in the form of apertures, are formed over a pitch circle diameter around the first opening 39 in the brush carrier plate 28. A securing element 50 can be fastened on the brush carrier plate 28 by means of the second openings 47, 48.

The securing element 50 in the form of a securing ring 51 illustrated in isolation in FIG. 5 centrally has a passage opening 52, which cooperates with the extension 41. As is known per se, the securing ring 51 further comprises several, in the exemplary embodiment six, securing sections 53, which are arranged at uniform angular distances from one another, protrude radially inwardly, project upwardly at an incline from the plane of the annular main body 54 and are used to grasp and position the securing ring 51 on the extension 41. On mutually opposed sides of the main body 54 of the securing ring 51, said main body has two fastening claws 56, 57 cooperating with the second openings 47, 48. The fastening claws 56, 57 formed integrally on the securing ring 51 have a section 59, which runs within the second openings 47, 48 approximately parallel to the axis of symmetry 58 of the securing ring 51 and to which a radially outwardly curved holding section 60 adjoins. The two fastening claws 56, 57 are elastically deformable radially in the direction of the axis of symmetry 58 toward the axis of symmetry 58, in such a way that, to fasten the securing ring 51 on the brush carrier plate 28, the fastening claws 56, 57 are pressed together radially inwardly so that they can be passed through the second openings 47, 48. As soon as the holding sections 60 are arranged on the side of the brush carrier plate 28 facing away from the securing sections 53, the radially active force on the fastening claws 56, 57 can be reduced, such that the holding sections 60 are operatively connected with the underside 61 of the brush carrier pate 28, as in accordance with FIG. 4, and fix or fasten the securing ring 51 on the brush carrier plate 28.

With securing rings 51 and brushes 38 assembled on the brush carrier plate 28, the brush carrier plate 28 is assembled within the housing base part 12 by introducing the brush carrier device 25 into the housing base part 12 in the direction of the arrow 45, that is to say in the longitudinal direction of the armature shaft 30, such that the first openings 39 are aligned or in line with the extensions 41. As the extensions 41 and the first openings 39 are moved axially relative to each other, the passage openings 52 in the securing rings 51 then come into contact with the extensions 41. By sliding on or pressing on the brush carrier plate 28 further in the direction of the arrow 45, the securing sections 53 expand radially, that is to say that a cross section is created that enables the securing rings 51 to be slid over onto the extensions 41. During this process, the securing sections 53 grip the extensions 41 in such a way that the brush carrier plate 28 cannot be withdrawn from the extensions 41 due to the inclined arrangement of the securing sections 53. The process of assembling the brush carrier plate 28 on the extensions 41 is complete as soon as the underside 61 of the brush carrier plate 28 rests against the respective shoulder 44 of the extension 41. The armature shaft 30, together with the collector 36, can then be introduced into the housing base part 12, wherein the collector 36 becomes operatively connected with the brushes 38 of the brush carrier device 25.

The windscreen wiper motor 10 described thus far can be altered or modified in a versatile manner, without departing from the scope of the inventive concept. For example, it is thus conceivable to use merely one extension 41, or else more than two extensions 41. In addition, other types of securing elements 50 are also conceivable. Lastly, the invention also is not limited to the use in a pot-shaped or cylindrical housing 11 in the region of the brush carrier plate 28.

### LIST OF REFERENCE SIGNS

10 windscreen wiper motor
11 housing
12 housing base part
13 transmission cover
14 bearing cover
16 transmission mounting region
17 cylindrical region
18 cooling rib
19 mounting opening
21 inner thread
22 outer thread
23 ring seal
24 flow ring
25 brush carrier device
28 brush carrier plate
29 aperture
30 armature shaft
31 toothing region
32 driving wheel
33 output shaft
34 lever
35 armature
36 collector
38 brush
39 openings
40 intermediate region
41 extension
42 first region
43 second region
44 shoulder
45 arrow
47 second opening
48 second opening
50 securing element
51 securing ring
52 passage opening
53 securing section
54 main body
56 fastening claw
57 fastening claw
58 axis of symmetry
59 section
60 holding section
61 underside

1. A windscreen wiper motor, comprising:
a shaft carrying an armature; and
a collector, wherein the collector cooperates with brushes, which are arranged on a brush carrier device,
wherein the brush carrier device is arranged fixedly in a windscreen wiper motor housing,
wherein the brush carrier device has at least a first opening constructed as an aperture, which is penetrated by a cone-shaped extension connected with the windscreen wiper motor housing, wherein on the side facing away from the fastening side of the extension in the windscreen wiper motor housing, the extension projects over the brush carrier device in the region of the at least one first opening, and
wherein a securing element is connected with the brush carrier device, which securing element on an axial moving relative to each other of the extension and of the securing element jams with the extension and thereby secures the brush carrier device on the extension in the longitudinal direction of the shaft.

2. The windscreen wiper motor according to claim 1, wherein the brush carrier device has a brush carrier plate which carries several brushes, wherein the brush carrier plate has an aperture for the guiding through of the shaft, and wherein two extensions and securing elements are provided, which are arranged in uniform angular distances around the aperture.

3. The windscreen wiper motor according to claim 1, wherein the windscreen wiper motor housing is constructed as an aluminium pressure die casting at least in the region of the at least one extension, and the at least one extension is a component part of the aluminium pressure die casting.

4. The windscreen wiper motor according to claim 1, wherein in the region of the brush carrier device and of the armature, the windscreen wiper motor housing is constructed in one piece cylindrically with a mounting opening for a bearing cover, wherein on the side lying opposite the mounting opening a radially inwardly projecting base region is provided, on which the at least one extension is arranged, pointing in the direction of the mounting opening.

5. The windscreen wiper motor according to claim 1, wherein the at least one extension has a first partial region, which is arranged in the region of the first opening of the brush carrier device, and a second partial region, which adjoins via a stepped shoulder on the side of the first partial region facing away from the brush carrier device, and wherein the shoulder forms an axial stop for the brush carrier device.

6. The windscreen wiper motor according to claim 1, wherein the securing element is constructed in the form of a securing disc with elastically deformable securing sections, which cooperate with the extension.

7. The windscreen wiper motor according to claim 6, wherein the securing disc has at least one fastening claw, which penetrates the brush carrier device in the region of a second opening constructed as a hole and fastens the securing disc on the brush carrier device such that a passage opening for the extension on the securing disc is aligned with the first opening.

8. The windscreen wiper motor according to claim 7, wherein the first opening of the brush carrier device in the region of the axial end position of the extension has a slightly greater cross-sectional area compared with the passage opening of the securing disc.

9. The windscreen wiper motor according to claim 7, wherein two fastening claws are provided, arranged offset radially with respect to each other through 180°, the fastening claws being arc arranged to as to be elastically movable in radial direction in relation to the longitudinal axis of the securing disc, and being held in the second opening under radial pre-stressing.

10. The windscreen wiper motor according to claim 5, wherein the first region of the extension is constructed in pin form with a conical shape.
